(19) United States
(12) Patent Application Publication
(10) Pub. No.: US 2019/0346220 A1
(43) Pub. Date: Nov. 14, 2019

(54) TITANIUM PLATE HEAT EXCHANGER

(71) Applicant: ALFA LAVAL CORPORATE AB, LUND (SE)

(72) Inventors: Per SJÖDIN, LUND (SE); Mats NILSSON, LUND (SE)

(73) Assignee: ALFA LAVAL CORPORATE AB, LUND (SE)

(21) Appl. No.: 16/335,178

(22) PCT Filed: Sep. 11, 2017
(86) PCT No.: PCT/EP2017/072679

§ 371 Date: Mar. 20, 2019

(30) Foreign Application Priority Data
Oct. 7, 2016 (SE) 1651317-8

(51) Int. Cl. F28F 21/08; B23K 1/00; F28D 9/00; F28F 3/04; F28F 3/02

(52) U.S. Cl. CPC F28F 21/086; B23K 1/0012; F28D 9/005; B32B 15/01; F28F 3/025; F28F 2275/04; F28F 3/046

(57) ABSTRACT

A plate heat exchanger includes a number of titanium plates arranged in a plate package. Every second plate is a titanium plate that has been cladded with a melting depressant foil on each side of the plate, and at least every second titanium plate has a corrugated pattern, such that tops and bottoms are formed in the plate. The cladded titanium plates are stacked on the corrugated titanium plates, so as to form the plate package of titanium plates. Contact areas are formed between adjacent titanium plates in the plate package. The plate package of titanium plates has been heated, such that the melting depressant foil has acted as a melting depressant for the titanium in the cladded titanium plates and caused surface layers of the cladded titanium plates to melt and flow to the contact areas between adjacent titanium plates and form joints at the contact areas between adjacent titanium plates when the melted titanium has been allowed to solidify.

### TECHNICAL FIELD

The invention relates to a titanium plate heat exchanger with permanently joined titanium plates.

The invention also relates to a method of producing a plate heat exchanger with plates that are made of titanium and to a metal coil that is used for producing the titanium plate heat exchanger.

### BACKGROUND ART

Today plate heat exchangers with permanently joined titanium plates are often manufactured by brazing the plates to each other. This is done by applying a brazing material on the plates and by heating the plates such that the brazing material melts and forms joints between the plates. The brazing material includes a so called filler metal, and it is this metal that forms the joints that joins the titanium plates. As for all brazing techniques of this type, the brazing material includes a melting depressant composition that causes the filler metal to melt at a temperature that is lower than the melting temperature of the titanium plates that are joined to each other.

A number of techniques exist for joining titanium plates into a plate heat exchanger. U.S. Pat. No. 7,201,973 describes one such technique, where the brazing material incudes an amount of 30 to 50 wt % titanium (Ti), 15 to 25 wt % zirconium (Zr), 15 to 25 wt % copper (Cu) and 15 to 25 wt % nickel (Ni). More specifically, the used brazing material includes 40 wt % Ti, 20 wt % Zr, 20 wt % Cu and 20 wt % Ni. The titanium is the filler metal while the other metals act as melting depressant components for the titanium.

The filler metal and the melting depressant components typically have the form of metal powders. To bind the metal powder, the brazing material typically also includes a binder composition that gives the brazing material the form of a paste or a liquid that may be sprayed, painted or in another suitable way applied on the titanium plates. It is important that the brazing material is properly applied on the titanium plates, in the correct amounts and on the correct places.

Titanium is a material that has many advantages in connection with brazed plate heat exchangers, e g because of the ability to withstand highly corrosive media such as sea water. Furthermore, titanium has low weight and a low thermal expansion coefficient which is beneficial in applications where the temperature varies. However, a problem encountered with brazed titanium plate heat exchangers is that they have low pressure resistance in comparison with e g brazed plate heat exchangers made of stainless steel.

Thus, there is a need for improving a titanium plate heat exchanger for high pressure applications, which typically rely on very traditional brazing techniques.

### SUMMARY

It is an object of the invention to provide an improved titanium plate heat exchanger for high pressure applications that is made of permanently joined titanium plates.

Thus, a plate heat exchanger is provided that comprises a number of titanium plates arranged in a plate package, wherein every second plate is a titanium plate that has been cladded with a melting depressant foil on each side of the plate, and at least every second titanium plate has a corrugated pattern, such that tops and bottoms are formed in the plate, wherein the cladded titanium plates are stacked on the corrugated titanium plates, so as to form the plate package of titanium plates, wherein contact areas are formed between adjacent titanium plates in the plate package, and wherein the plate package of titanium plates has been heated, such that the melting depressant foil has acted as a melting depressant for the titanium in the cladded titanium plates and caused surface layers of the cladded titanium plates to melt and flow to the contact areas between adjacent titanium plates and form joints at the contact areas between adjacent titanium plates when the melted titanium has been allowed to solidify

The plate heat exchanger is advantageous in that it has improved high pressure performance and can still maintain good titanium. Furthermore, the plate heat exchanger is advantageous in that no binder composition must be used for accomplishing the joints, and in that no material, such as a brazing material, must be applied on the plates after they have been corrugated.

A method for producing the plate heat exchanger as well as a metal coil that is suitable for use with the method is also described, and provides corresponding advantages.

Other objectives, features, aspects and advantages of the plate heat exchanger will appear from the following detailed description as well as from the drawings

### BRIEF DESCRIPTION OF THE DRAWINGS

Embodiments of the invention will now be described, by way of example, with reference to the accompanying schematic drawings, in which

FIG. 1 is a side view of a titanium plate heat exchanger,

FIG. 2 is a front view of the titanium plate heat exchanger of FIG. 1,

FIG. 3 is a front view of a mainly flat titanium plate that is part of the plate heat exchanger of FIG. 1,

FIG. 4 is a front view of a corrugated titanium plate that is part of the plate heat exchanger of FIG. 1,

FIG. 5 illustrates a cross-section of the titanium plate of FIG. 3, cladded with a melting depressant foil,

FIG. 6 illustrates how a titanium plate is cladded with a melting depressant foil,

FIG. 7 is an enlarged, partial view of two titanium plates at a contact point, before they are joined,

FIG. 8 is an enlarged, partial view of the two titanium plates in FIG. 7, after they have been joined,

FIG. 9 illustrates a coil that is made of a titanium plate that has been clad with a melting depressant foil,

FIG. 10 is a flow schedule that illustrates a method of producing a titanium plate heat exchanger like the one in FIG. 1, and

FIG. 11 shows a cross-section of the obtained plate package in FIG. 1.

### DETAILED DESCRIPTION

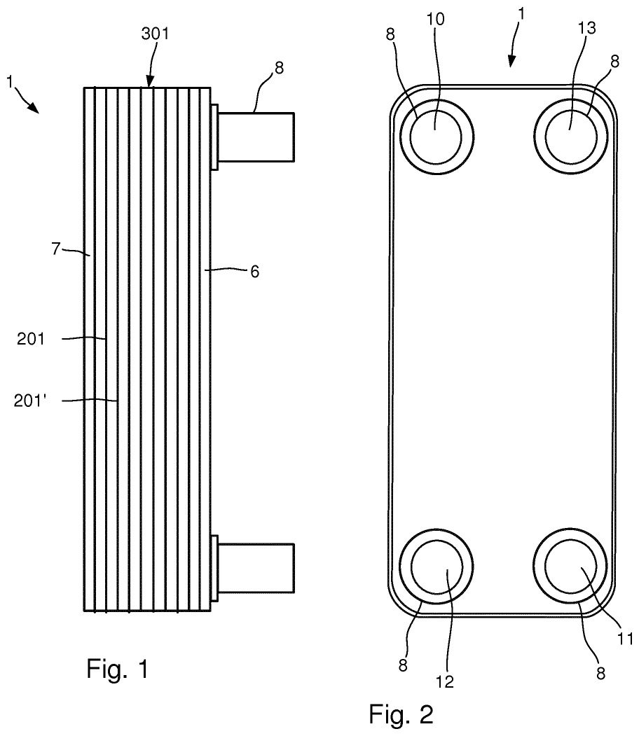

With reference to FIGS. 1 and 2 a plate heat exchanger 1 is illustrated. The plate heat exchanger 1 is primarily made of titanium and is thus referred to as a “titanium plate heat exchanger”. The plate heat exchanger 1 comprises a plate package 301 of titanium plates 201, 201′, and a first end plate 6 that is arranged on a first side of the plate package 301 and a second end plate 7 that is arranged on a second side of the plate package 301. The end plates 6, 7 may have the same shape and form as the titanium plates in the plate package 301, but are slightly thicker for providing protection against external forces.

The titanium plates 201, 201′are permanently joined to each other to form the plate package 301 and has alternating first and second flow paths for a first fluid and a second fluid that flow in between the titanium plates. The plate heat exchanger 1 may have a first fluid inlet 10 and a first fluid outlet 11. The first fluid inlet 10 receives the first fluid and leads the first fluid to the first flow path between the titanium plates in the plate package 301. The first fluid outlet 11 receives the first fluid from the first flow path and allows the fluid to exit the plate heat exchanger 1. The plate heat exchanger 1 has a second fluid inlet 12 and a second fluid outlet 13. The second fluid inlet 12 receives the second fluid and leads the second fluid to the second flow path between the titanium plates. The second fluid outlet 13 receives the second fluid from the second flow path and allows the second fluid to exit the plate heat exchanger 1.

Connectors 8 are arranged around each of the inlets and the outlets, and each connector 8 has the form a pipe. Fluid lines for the two fluids may then be connected to the plate heat exchanger 1 via the connectors 8. Any suitable technique may be used for accomplishing such connection, and the connectors 8 are typically made of the same material as the titanium plates in the plate package 301. Inlets and outlets for one of the fluids me be reversed, such that there is a co-current flow of the fluids, instead of a counter flow as illustrated.

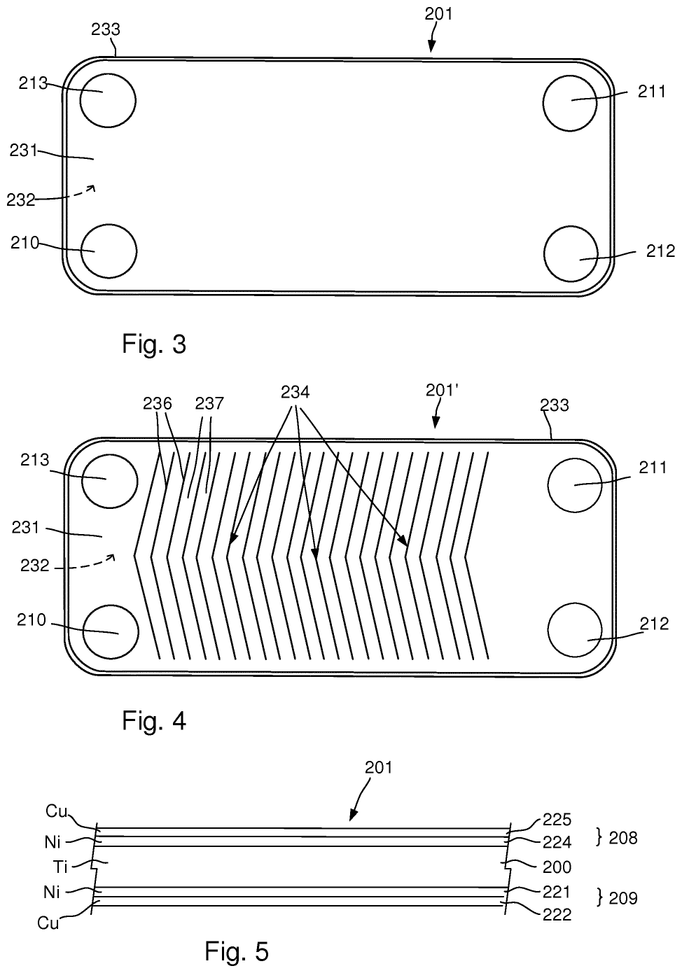

With reference to FIG. 3 a first titanium plate 201 is shown, which may be flat, i e having no corrugated pattern of elevations and depressions, or mainly flat. By mainly flat is intended a surface enlargement of <5% after the plate has been corrugated, e g by pressing. The surface enlargement of the corrugated plate 201′ is <25%. In FIG. 4 a second titanium plate 201′ which has a corrugated pattern is illustrated. The titanium plates 201′ has been corrugated such that The titanium plates 201 and 201′ are arranged alternatively on top of each other. The titanium plates 201′ and 201 may have four through holes 210-213, also referred to as port openings, which are aligned with the inlets and outlets 10-13 of the plate heat exchanger 1. A pattern 234 in form of alternating tops 236 and bottoms 237 is arranged e g by pressing into the titanium plate 201′. Also the titanium plate 201 may be provided with a corrugated pattern of alternating tops and bottoms or it may be mainly flat, i e having a surface enlargement after corrugation of <5%. The titanium plates 201, 201′ have a first side 231 and a second side 232 that is opposite the first side 231. A peripheral edge 233 may extend around the titanium plates 201 and 201′ and is folded from the first side 231 towards the second side 232. The edge 233 abuts an underlying titanium plate and provides a seal to the periphery to the underlying titanium plate.

The forms and shapes of the plate heat exchanger 1, the fluid paths for the fluids, the titanium plates 201′ and 201 and the connectors 8 are per se known within the art and can be accomplished according to known techniques. However, the plate heat exchanger 1 is produced in a new manner, by using a plate material with special properties that effectively joins the titanium plates in the plate package 301. The titanium plate 201′ is made of a high grade titanium plate with a corrugated pattern. The thickness thereof is 0.25 to 2.0 mm. Due to the high grade titanium material the plate can be corrugated to a surface enlargement of up to 25% without cracks occurring which can withstand high pressures above 16 bar, up to 32 bar. Reference numeral 201 indicates a titanium plate mainly made of titanium but which may be made of a lower grade titanium and with no pressed pattern except for the peripheral edge 233. When the titanium plate 201 is not corrugated the quality requirements on the titanium material is lower in view of surface enlargement. However, the titanium plate 201 may also be provided with a corrugated pattern. In such a case the quality requirements of the titanium plate are higher.

With reference to FIG. 5 a cross-section of the titanium plate 201 is illustrated as it appears before it has been joined with an adjacent corrugated titanium plate 201′. The titanium plate 201 has a core in form of a titanium plate 200. A first melting depressant foil 208 is arranged on the first side 231 of the titanium plate 200. The first melting depressant foil 208 comprises a nickel (Ni) foil 224 and a copper (Cu) foil 225. Instead of the copper foil 225 a zirconium (Zr) foil may be used. The nickel foil 224 is arranged closest to the titanium plate 200. The titanium plate 200 has a thickness of 0.25 to 2.0 mm and may be made of lower grade titanium. The titanium plate 200 may have a greater thickness, such 1.5 to 5.0 mm, before a melting depressant foil is cladded on the plate 200. Cladding may reduce the thickness of the titanium plate, for example if the cladding is accomplished by cold roll bonding. The final thickness of the titanium plate after it has been cladded with melting depressant foil is typically 0.25 to 2.0 mm. The titanium core 200 is the major part of the titanium plate 201.

The copper foil 225 comprises at least 98% pure copper and the nickel foil 224 comprises at least 98% pure nickel. Remaining percentages of the copper foil 225 and the nickel foil 224 may be other alloy metals or impurities. In case a zirconium foil is used, this foil would comprise at least 98% pure zirconium.

Each of the copper foil 225 and the nickel foil 224 has a thickness that is less than 20%, or less than 10%, or less than 4% of a thickness of the titanium plate 200, or the plate 201, which includes the melting depressant foils. A zirconium foil would also have a thickness that is less than 20%, or less than 10%, or less than 4% of a thickness of the titanium plate 200 or the plate 201. Thus, each of the copper foil 225, the nickel foil 224 and, if it is used, the zirconium foil, has a thickness that is less than 20%, or less than 10%, or less than 4% of the thickness of the titanium plate 201, i.e. the thickness of the titanium plate 200 plus the thickness of all melting depressant foils that are arranged on the titanium plate 200. For example, the titanium plate 200 may have a thickness of 1 mm, the nickel foil 224 may have a thickness of 0.015 mm and the copper foil 225 may have a thickness of 0.015 mm.

A second melting depressant foil 209 is arranged on a second side of the titanium plate 200. The second melting depressant foil 209 comprises a nickel foil 221 and a copper foil 222. Instead of the copper foil 225 a zirconium foil may be used. The nickel foil 221 is arranged closest to the titanium plate 200. The foils 221, 222 of the second melting depressant foil 209 are identical to the foils of the first melting depressant foil 208. As will be described below, other configurations of melting depressant foils may be used.

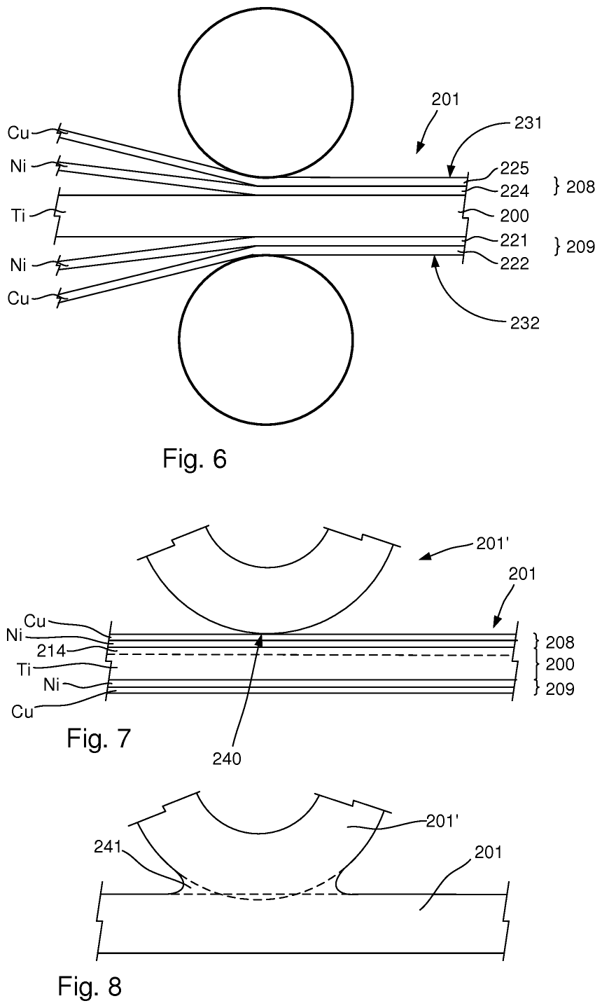

With reference to FIG. 6, the titanium plate 201 is obtained by cladding the titanium plate 200 with the first melting depressant foil 208 and the second melting depressant foil 209, on a respective side 231, 232 of the plate 201, i.e. on a respective side of the titanium core 200. The cladding may be accomplished by rolling, for example by conventional cold roll bonding techniques. The melting depressant foils 208, 209 are then effectively bonded together with the titanium plate 200. Of course, any other suitable technique may be used for bonding the melting depressant foils to the titanium plate 201.

During cold roll bonding a high pressure is applied on the layers, i.e. on the copper foils, the nickel foils and the on titanium plate 200. This may in an undesirable manner change the ductile properties of in particular the titanium in the plate 201. To regain or at least improve the ductile properties of the plate 201 it may be heat treated after the cold rolling. This is done at a temperature of about 650 to 850° C., for a predetermined time and in accordance with the principles of conventional heat treating of titanium.

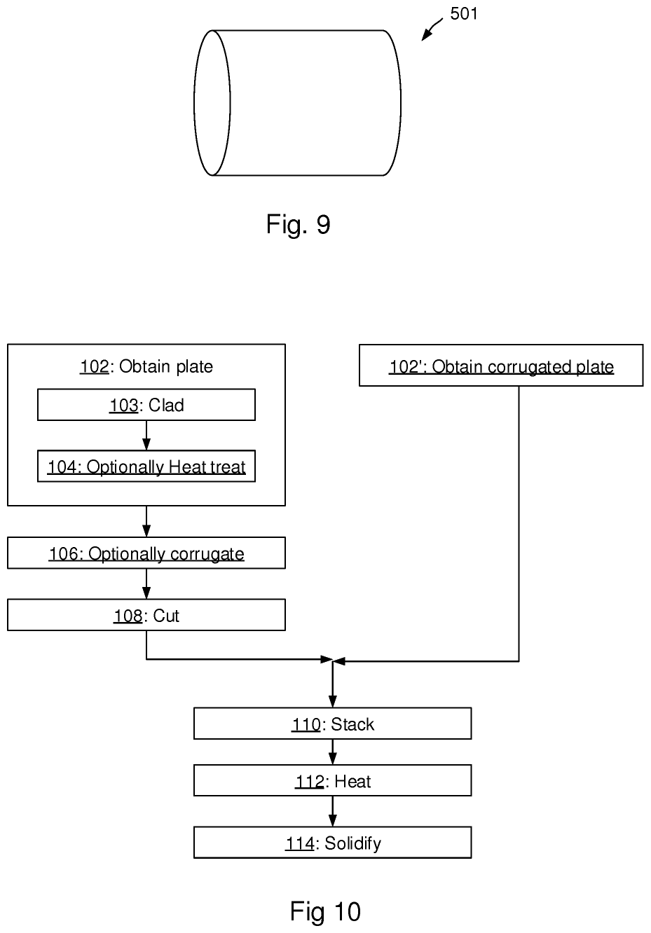

The plate 201 with the titanium core 200 and melting depressant foils 208, 209 may be formed as a continuous strip with a desired width. The strip may be rolled into a coil 501, as illustrated by FIG. 9. The heat treatment may be performed before forming the coil or after the coil has been formed.

With reference to FIGS. 7 and 8, when a titanium plate 201 in the plate package 301 is heated to a temperature just below the melting temperate of titanium, then the melting depressant foils 208, 209 act as melting depressants for the titanium 200 in the plate 201 and causes the surface layers 214 of the plates 201 to melt. The temperature is above 850° C. and below the melting point of titanium, or below 1050° C. All surface layers of all titanium plates 200 that are in contact with the melting depressant foils 208, 209 melt, and how much of the surface layer 214 that melt is determined by the thickness of the copper and nickel foils of the melting depressant foils 208, 209. When the corrugated plates 201′ made entirely of high grade titanium and the cladded titanium plates 201 of titanium with melting depressant foils, are arranged in contact with each other, the melted titanium in the melted surface layer 214 flows, by way of capillary forces, towards the contact areas 240 between the plates 201, 201′. After this the melted titanium is allowed to cool down and thereby solidify, with the result that joints 241 are formed at the contact areas 240 between adjacent plates 201, 201′, at the point to where the melted titanium flowed. All titanium in the joint then comes from titanium that was part of surface layer 214 of the plate 201. Thus, a self-brazing titanium plate has been accomplished. If titanium is added in some other way, for example by including some in the melting depressant foils, then not all titanium comes from the titanium plates in the plate package 301. However, typically at least 80% or at least 90% of the titanium in the joints 241 is, before the joining, part of a titanium plate 201 in the plate package 301 of titanium plates.

With reference to FIG. 10, a method of producing a titanium plate heat exchanger like the one in FIG. 1 comprises a number of steps. In a first step a titanium plate 201 is obtained 102. The obtained titanium plate 201 may come e.g. in form of a coil, and has been cladded 103 with the melting depressant foil 208 on each side 231, 232 of the plate 201. Even though it is not necessary, the plate may have been heat treated 104 after the cladding 103, as described above.

A conventional operation of corrugating the pattern 234 in the plate 201′ is performed, which forms the tops 236 and bottoms 237 in the plate 201′. The corrugating typically comprises pressing the titanium plate 201′ with a press depth of at least 1.5 mm, as seen from the highest top to the lowest bottom in the plate. The plate has after this operation become a corrugated titanium plate 201′. Optionally the cladded titanium plate 201 may also be corrugated and the pressing 106 typically comprises pressing the titanium plate 201 with a press depth of at least 1.5 mm, as seen from the highest top to the lowest bottom in the plate. The surface of the titanium plate 201 is thus covered with the melting depressant foil 208. The plate has after this operation become a cladded heat transfer plate 201, and is referred to as a titanium plate, even though it is not only made of titanium (its melting depressant foil is made of another material).

The plates 201 may be cut 108 to a predetermined shape. This includes cutting the plate 201 along its peripheral edge 233 and cutting the through holes 210-213.

Next a number of titanium plates 201, 201′ are alternately stacked 110 on top of each other, such that the plate package 301 of titanium plates 201, 201′ is formed, wherein every second plate is a is a mainly flat cladded plate 201 and every second plate is a corrugated titanium plate 201′. The mainly flat cladded titanium plates 201 may have a minor corrugation, e g resulting in a surface enlargement of <5%. However, the surface enlargement of the corrugated plates 201′ should be larger than the surface enlargement of the cladded titanium plates 201. During the stacking the plates come in contact with each other, and contact areas 240 are thus formed between adjacent titanium plates 201, 201′ in the plate package 301.

The operations for corrugating 106, cutting 108 and stacking 110 plates are performed according to known techniques, such as pressing. The end plates 6, 7 are similar to the plate 201, with the difference that the titanium core is thicker. The connectors 8 may be omitted depending on the intended use of the plate heat exchanger 1. If the connectors 8 are used they may be made of the same titanium as the plate 201′, and may be attached to the plate package 301 by using conventional titanium brazing techniques.

Next the plate package 301 of titanium plates is heated 112 to a temperature above 850° C. and below the melting point of titanium. As explained, the melting depressant foil 208 then acts as a melting depressant for the titanium in the titanium plates 201 and cause surface layers 214 of the titanium plates 201 to melt. The melted titanium then flows to the contact areas 240 between adjacent titanium plates 201, 201′. Thereafter the melted titanium is allowed 114 to solidify (cool) with the result that joints 241 are formed at the contact areas 240 between adjacent titanium plates 201, 201′. The titanium plates in the plate package 301 are then effectively joined.

Times and temperatures for performing the step of heating 112 and cooling 114 may depend on the configuration and the thickness the melting depressant foils. For a plate where the titanium core is 0.45 mm thick and where each melting depressant foil comprises a copper foil with a thickness of 3 μm, a nickel foil with a thickness of 6 μm and a copper foil with a thickness of 3 μm, then the heating 112 and cooling 114 may be performed according to the example cycle below. In this example the nickel (Ni) foil is located between two copper (Cu) foils, and both sides of the titanium (Ti) are cladded with the melting depressant foil. Thus, the example is a so called Cu—Ni—Cu—Ti—Cu—Ni—Cu plate configuration. A conventional brazing oven was used when performing the cycle. Other plate configurations, i.e. combinations of Cu, Ni and/or Zr foils that form the melting depressant foil may be used, as described further on and as previously illustrated (FIG. 5 shows a Cu—Ni—Ti—Ni—Cu plate configuration).

The cycle included heating the plate package 301, which had 20 plates, from 22° C. to 550° C. during a period of 30 minutes, holding the temperature at 550° C. for a period of 20 minutes, flushing the plate package with argon gas for 10 minutes at 550° C. and thereafter evacuating the argon gas to perform the following steps in vacuum. The following steps include increasing the temperature to 900° C. during a period of 20 minutes, holding the temperature at 900° C. for 30 minutes, increasing the temperature to 1025° C. during a period of 5 minutes, holding the temperature at 1025° C. during a period of 30 minutes, reducing the temperature to 900° C. for during a period of 30 minutes, and holding the temperature at 900° C. for 30 minutes. Thereafter the vacuum is released, the oven is shut off and the plate package 301 is allowed to cool down inside the oven until it reaches a temperature of 22° C. (the surrounding temperature).

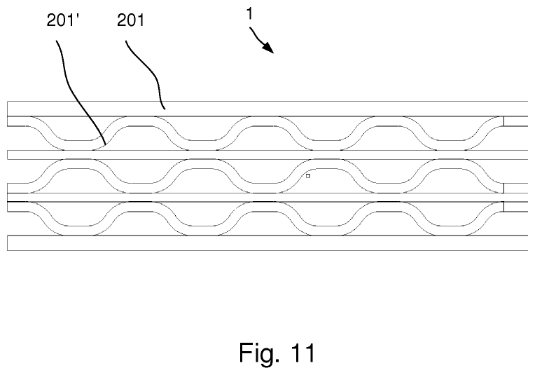

The obtained plate package 301 was perfectly sealed at all contact areas between the titanium plates in the plate package 301. In FIG. 11 is shown a cross sectional view of the obtained plate package 301.

Other cycles for brazing the plate package 301 of titanium plates may be used, and it is estimated that conventional titanium brazing cycles be used.

The described example was performed for a Cu—Ni—Cu—Ti—Cu—Ni—Cu plate configuration. Other configurations may be used, including the following which indicate the order of the foils, where “Cu” represents a copper foil, “Ni” represents a nickel foil, “Zr” represents a zirconium foil and “Ti” represents a titanium plate: Ni—Cu—Ti—Cu—Ni, Cu—Ni—Ti—Ni—Cu, Zr—Ni—Ti—Ni—Zr, Zr—Ni—Cu—Ti—Cu—Ni—Zr, Ni—Ti—Ni, Cu—Ti—Cu, Ni—Ti—Cu, Cu—Ti—Ni. Other combinations are possible, for example may Zr replace Cu for one or more of the embodiments, partly or in full. More layers of Ni, Cu and Zr may also be used, and their order may be changed.

The described plate heat exchanger is only one example of a type of plate heat exchanger that the production method may be used for. Any other suitable plate heat exchanger type may be produced according to the method, including types that have other type of plate patterns, other number of port openings in the plates etc.

From the description above follows that, although various embodiments of the invention have been described and shown, the invention is not restricted thereto, but may also be embodied in other ways within the scope of the subject-matter defined in the following claims.

1. A plate heat exchanger comprising:
a number of titanium plates arranged in a plate package,
wherein every second plate is a titanium plate that has been cladded with a melting depressant foil on each side of the plate, and at least every other second titanium plate has a corrugated pattern, such that tops and bottoms thereof are formed in the plate,
wherein the cladded titanium plates are stacked on the corrugated titanium plates, so as to form the plate package of titanium plates,
wherein contact areas are formed between adjacent of the number of titanium plates in the plate package, and
wherein the plate package of titanium plates has been heated, such that the melting depressant foil has acted as a melting depressant for the titanium in the cladded titanium plates and caused surface layers of the cladded titanium plates to melt and flow to the contact areas between adjacent of the number of titanium plates and form joints at the contact areas between adjacent of the number of titanium plates when the melted titanium has been allowed to solidify.

2. The plate heat exchanger according to claim 1, wherein the corrugated titanium plates have been corrugated, such that tops and bottoms are formed in the plate, and the surface enlargement of the corrugated plates is larger than the surface enlargement of the cladded titanium plates.

3. The plate heat exchanger according to claim 1, wherein the cladded titanium plates have been corrugated, such that tops and bottoms are formed in the plate, to a surface enlargement which is <5%.

4. The plate heat exchanger according to claim 1, wherein the cladded titanium plates are mainly flat.

5. The plate heat exchanger according to claim 1, wherein the number of titanium plates have a thickness of 0.25 to 2.0 mm.

6. The plate heat exchanger according to claim 1, wherein the melting depressant foil comprises:
a nickel foil; and
any of a copper foil and a zirconium foil.

7. The plate heat exchanger according to claim 1, wherein the melting depressant foil is cladded on a first side of the cladded titanium plates and a second melting depressant foil is cladded on a second side of the cladded titanium plates, each of the first and second melting depressant foils comprising, respectively:
a first copper foil;
a nickel, foil; and
a second copper foil,
wherein the nickel foil is located between the first and second copper foils.

8. The plate heat exchanger according to claim 6, wherein the nickel foil has a thickness that is less than 20% of a thickness of the cladded titanium plate.

9. The plate heat exchanger according to claim 6, wherein the copper foil has a thickness that is less than 20% of a thickness of the cladded titanium plate.

10. The plate heat exchanger according to claim 6, wherein the zirconium foil has a thickness that is less than 20% of a thickness of the cladded titanium plate.

11. The plate heat exchanger according to claim 6, wherein the cladded titanium plates have been cladded with the copper foils and the nickel foils by rolling.

12. The plate heat exchanger according to claim 1, wherein the cladded titanium plates have been heat treated at a temperature of 650 to 850° C.

13. The plate heat exchanger according to claim 1, wherein the corrugated titanium plates have a press depth of at least 1.5 mm.

14. The plate heat exchanger according to claim 1, wherein the cladded titanium plate comprises titanium, and the melting depressant foil comprises any of:
a copper foil that comprises at least 98% pure, copper;
a nickel foil that comprises at least 98% pure, nickel and
a zirconium foil that comprises at least 98% pure zirconium.

15. The plate heat exchanger according to claim 1, wherein at least 90% of the titanium in the joints was, before the heating, part of any one of the cladded titanium plates in the plate package of titanium plates.

16. A method of producing a plate heat exchanger, comprising the steps of:
obtaining a titanium plate that has been cladded with a melting depressant foil on each side of the plate,
corrugating a pattern on a titanium plate, such that tops and bottoms are formed in the plate;
stacking the cladded titanium plates on a number of corrugated titanium plates, so as to form a plate package, wherein every second plate is a cladded titanium plate and every other second plate is a corrugated titanium plate, where contact areas are formed between adjacent titanium plates in the plate package of titanium plates,
heating the plate package of titanium plates to a temperature above 850° C. and below the melting point of titanium, such that the melting depressant foil acts as a melting depressant for the titanium in the cladded titanium plates and causes surface layers of the cladded titanium plates to melt, the melted titanium thereby flowing to the contact areas between adjacent titanium plates,
allowing the melted titanium to solidify and form joints at the contact areas between adjacent titanium plates.

17. The method according to claim 16, wherein the heating comprises heating to a heating temperature of 850 to 1050° C.

18. The plate heat exchanger according to claim 2, wherein the number of titanium plates-have a thickness of 0.25 to 2.0 mm.

19. The plate heat exchanger according to claim 3, wherein the number of titanium plates have a thickness of 0.25 to 2.0 mm.

20. The plate heat exchanger according to claim 4, wherein the number titanium plates have a thickness of 0.25 to 2.0 mm.
